(19) United States
(12) Patent Application Publication
(10) Pub. No.: US 2012/0247205 A1
(43) Pub. Date: Oct. 4, 2012

(54) Sensor module and method for manufacturing a sensor module

(76) Inventors: Michael Hortig, Eningen Unter Achalm (DE); Thomas Schrimpf, Reutlingen (DE)

(21) Appl. No.: 13/432,159

(22) Filed: Mar. 28, 2012

(30) Foreign Application Priority Data
Mar. 31, 2011 (DE) 10 2011 006 594.6

(51) Int. Cl. G01D 11/24; H01R 43/00

(52) U.S. Cl. 73/431; 29/825

(57) ABSTRACT

A sensor module has an electrically conductive part, a first sensor element, and a second sensor element, the first sensor element being situated in a first accommodating area of the conductive part, and the second sensor element being situated in a second accommodating area of the conductive part, and the conductive part furthermore having a bent area situated between the first and the second accommodating areas so that the second accommodating area is oriented at an angle with respect to the first accommodating area.

### RELATED APPLICATION INFORMATION

The present application claims priority to and the benefit of German patent application no. 10 2011 006 594.6, which was filed in Germany on Mar. 31, 2011, the disclosure of which is incorporated herein by reference.

### FIELD OF THE INVENTION

The present invention is directed to a sensor module.

### BACKGROUND INFORMATION

Such sensor modules are generally understood. For example, from the publication DE 10 2007 057 441 A1 a sensor module is discussed, which has a sensor chip situated on a printed circuit board and a module housing. The sensor module may be contacted from the outside via a connector pin.

A carrier element system having a first and a second carrier element, a first sensor being situated on the first carrier element, and a second sensor being situated on the second carrier element is furthermore discussed in the publication DE 10 2007 052 366 A1. The first and the second carrier elements are configured as separate components, which are situated perpendicularly to each other. The configuration of the first and the second sensors perpendicularly to each other allows at least two vector quantities, which are perpendicular to each other, to be measured. In particular, the quantity to be measured may be divided into at least two individual directional components with the aid of the two sensors which are independent of each other and perpendicular to each other.

### SUMMARY OF THE INVENTION

The sensor module according to the present invention and the method according to the present invention for manufacturing a sensor module according to the further descriptions herein have the advantage over the related art that an angular configuration of the first and the second sensor elements is achieved in a simple, compact (with regard to installation space) manner and in a manner which is cost-effectively implementable. In this way, vector quantities such as accelerations, angular accelerations, magnetic fields, electric fields, and the like may be measured along at least two directions deviating from each other. In particular, the division of a quantity to be measured into at least two individual directional components with the aid of the two sensor elements situated at an angle to each other is possible.

Compared to the related art, only one single conductive part is needed for this purpose, which is simply bent, i.e., angled or kinked between the first and the second accommodating areas. The use of two separate carrier boards or printed circuit boards is not necessary, so that a relatively complex connecting or joining technique for connecting such separate carrier boards or printed circuit boards is fully dispensable. The conductive part may include a metallic insert. However, it is also conceivable that the conductive part includes a flexible printed circuit board. The first and the second sensor elements may include each an electric, electronic, mechanical, and/or micromechanical sensor, particularly may be an acceleration sensor, an angular acceleration sensor, a sensor for measuring an electric field, and/or a sensor for measuring a magnetic field (for example, a Hall sensor). The conductive part may be bent in the bent area in such a way that a main plane of extension of the conductive part in the first accommodating area and a main plane of extension of the conductive part in the second accommodating area form an angle of essentially 90° or the angle is between 1° and 89° or between 91° and 179°.

Advantageous embodiments and refinements of the exemplary embodiments and/or exemplary methods of the present invention are derivable from the further descriptions herein and the description with reference to the drawings.

According to one specific embodiment it is provided that the first accommodating area is angled with respect to the second accommodating area at essentially 90°. Two quantities which are perpendicular to each other and independent of each other may thus be advantageously measured.

According to one specific embodiment it is provided that the sensor module has a third sensor element, the third sensor element being situated in a third accommodating area of the conductive part, the conductive part having another bent area situated between the second and the third accommodating areas, so that the third accommodating area is angled with respect to the second accommodating area. With the aid of the third sensor element, vector quantities such as accelerations, angular accelerations, magnetic fields, electric fields, and the like may be advantageously measured along three spatial directions deviating from each other. In particular, the division of a quantity to be measured into all three directional components with the aid of the three sensor elements situated at an angle to each other is thus possible. It is also conceivable that in the first accommodating area a plurality of first sensor elements, in the second accommodating area a plurality of second sensor elements, and/or in the third accommodating area a plurality of third sensor elements are situated.

According to one specific embodiment it is provided that the third accommodating area is oriented essentially perpendicularly to both the first accommodating area and the second accommodating area. This makes it advantageously possible to measure the three independent spatial directions of a Cartesian coordinate system X, Y, Z.

According to one specific embodiment it is provided that the conductive part is at least partially enclosed by a housing, which may include an injection-molded plastic material. The housing may be manufactured relatively easily and cost-effectively by an injection-molding process. Alternatively, however, the use of a prefabricated housing, for example, a premolded housing, is also conceivable. The housing is used to protect the sensor elements against external environmental influences such as the effect of mechanical forces, moisture, acids, or the like.

According to one specific embodiment it is provided that the conductive part has a first fastening clamp for fastening the first sensor element in the first accommodating area, a second fastening clamp for fastening the second sensor element in the second accommodating area, and/or a third fastening clamp for fastening the third sensor element in the third accommodating area. A relatively reliable and easy-to-produce fastening of the sensor elements is thus advantageously achieved. The first, the second, and/or the third fastening clamp may be elastically pre-stressed in the direction of the first, the second, and/or the third accommodating areas, respectively, so that the first sensor element may be fastened between the first fastening clamp and the first accommodating area, the second sensor element between the second fastening clamp and the second accommodating area, and/or the third sensor element between the third fastening clamp and the third accommodating area. A form-locked and force-fitted fastening of the sensor element is thus achieved. Each fastening clamp may include particularly a metallic clip, which is partially stamped into the conductive part, and bent outward.

Another aspect of the exemplary embodiments and/or exemplary methods of the present invention is a method for manufacturing a sensor module, in particular according to one of the preceding, in a first step, a conductive part being provided, which has a first accommodating area for accommodating a first sensor element and a second accommodating area for accommodating a second sensor element, and in a second step the conductive part is bent in an area situated between the first and the second accommodating areas in such a way that the second accommodating area is angled with respect to the first accommodating area. The method according to the present invention allows a sensor module having sensor elements angled with respect to each other to be manufactured in a considerably simpler manner compared to the related art, since only one single conductive part is needed and no separate printed circuit boards are to be connected at a right angle to each other.

The manufacturing costs are thus considerably reduced, since bending procedures are implementable relatively simply and cost-effectively. In addition, due to the one-piece configuration of the conductive part, no contacting errors which may occur in the sensor modules known from the related art at the joints between the separate printed circuit boards are to be feared, since the circuit-board conductors between the different accommodating areas are only bent, but not interrupted at any point. In particular, the term accommodating area is understood to mean in the sense of the present invention that the particular sensor element is fastened (which may be planarly) to the particular accommodating area. The accommodating area thus performs a holding function.

According to one specific embodiment it is provided that in the first method step a conductive part is provided, which furthermore has a third accommodating area for accommodating a third sensor element, and that in a third method step the conductive part is bent in an additional area situated between the second and the third accommodating areas in such a way that the third accommodating area is angled with respect to the second accommodating area. The integration of three sensor elements in three different planes using one single conductive part is thus advantageously achieved. In particular, three directional components which are independent of each other may thus be measured. In the first method step the conductive part may have an L shape or a U shape, so that by bending twice (to produce the bent area and the additional bent area) the first, the second, and the third accommodating areas may be oriented at a right angle to each other.

According to one specific embodiment it is provided that in a fourth method step the first sensor element is situated in the first accommodating area, the second sensor element is situated in the second accommodating area, and/or the third sensor element is situated in the third accommodating area with the aid of a soldering, gluing, clamping, and/or insertion procedure. Optionally it is also conceivable that a socket is situated in the particular accommodating area for accommodating the particular sensor element.

According to one specific embodiment it is provided that, in a fifth method step for manufacturing a housing, the conductive part, together with the first, the second, and/or the third sensor element is extrusion coated using a plastic, thus achieving a cost-effective manufacturing of the housing.

Alternatively, in the fifth method step, the conductive part, together with the first, the second, and/or the third sensor element, may situated in a premolded housing.

Exemplary embodiments of the present invention are illustrated in the drawings and explained in greater detail in the description that follows.

### BRIEF DESCRIPTION OF THE DRAWINGS

FIG. 1 shows a schematic sectional view of a sensor module according to a first specific embodiment of the present invention.

FIG. 2 shows a schematic sectional view of a sensor module according to a second specific embodiment of the present invention.

FIGS. 3a and 3b show schematic top views of a conductive part, in the initial state, of a sensor module according to a third and a fourth specific embodiment of the present invention.

FIGS. 4a and 4b show schematic top views of a conductive part, in the initial state, of a sensor module according to a fifth and a sixth specific embodiment of the present invention.

### DETAILED DESCRIPTION

In the different figures, identical parts are provided with identical reference numerals and are therefore normally named or mentioned only once.

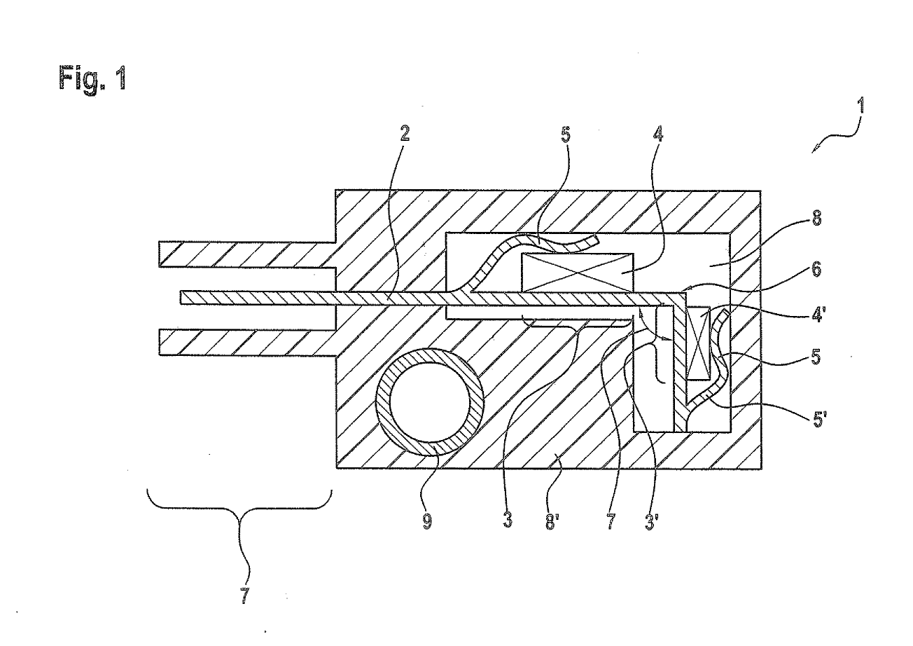

FIG. 1 shows a schematic sectional view of a sensor module 1 according to a first specific embodiment of the present invention. Sensor module 1 has a conductive part 2, which is configured as a metallic insert. Conductive part 2 has a first accommodating area 3, in which a first sensor element 4 is fastened with the aid of a first fastening clamp 5. In this case, first sensor element 4 is clamped between first fastening clamp 5, which is elastically pre-stressed in the direction of first accommodating area 3, and first accommodating area 3. Furthermore, first sensor element 4 is soldered to conductive part 2, glued with the aid of a conductive adhesive, and/or clamped in first accommodating area 3. Conductive part 2 furthermore similarly has a second accommodating area 3′, in which a second sensor element 4′ is fastened with the aid of a second fastening clamp 5′. In this case, second sensor element 4′ is clamped between second fastening clamp 5′, which is elastically pre-stressed in the direction of second accommodating area 3′, and second accommodating area 3′. Second sensor element 4′ is furthermore soldered to conductive part 2, or glued with the aid of a conductive adhesive, or clamped in second accommodating area 3′.

Conductive part 2 furthermore has a bent area 6 in the shape of a bend, which is formed between first and second accommodating areas 3, 3′. Conductive part 2 is bent or kinked in bent area 6 by an angle 7 in such a way that second accommodating area 3′ is angled with respect to first accommodating area 3. In the present exemplary embodiment second accommodating area 3′ is angled by an angle 7 of approximately 90° with respect to first accommodating area 3. However, other angles 7 between 0° and 180° would also be conceivable as alternatives. First and second sensor elements 4, 4′ may include micromechanical acceleration sensors or angular acceleration sensors, which sense vector acceleration quantities in two different planes due to their being situated at a right angle. Conductive part 2 ends in a plug area 7 of sensor module 1, via which first and second sensor elements 4, 4′ may be electrically contacted, i.e., read or controlled from the outside. Conductive part 2 may include a plurality of bus lines for contacting first and second sensor elements 4, 4′, for example, with the aid of a bus-compatible transmission protocol.

Conductive part 2 is integrated, together with first and second sensor elements 4, 4′, into an internal housing 8 injection-molded from plastic in the area of first sensor element 4, second sensor element 4′, and bent area 6. Sensor module 1 furthermore has an external housing 8′, which directly encloses internal housing 8 and indirectly encloses plug area 7. External housing 8′ may also be manufactured in a plastic injection-molding process and has a fastening bushing 9.

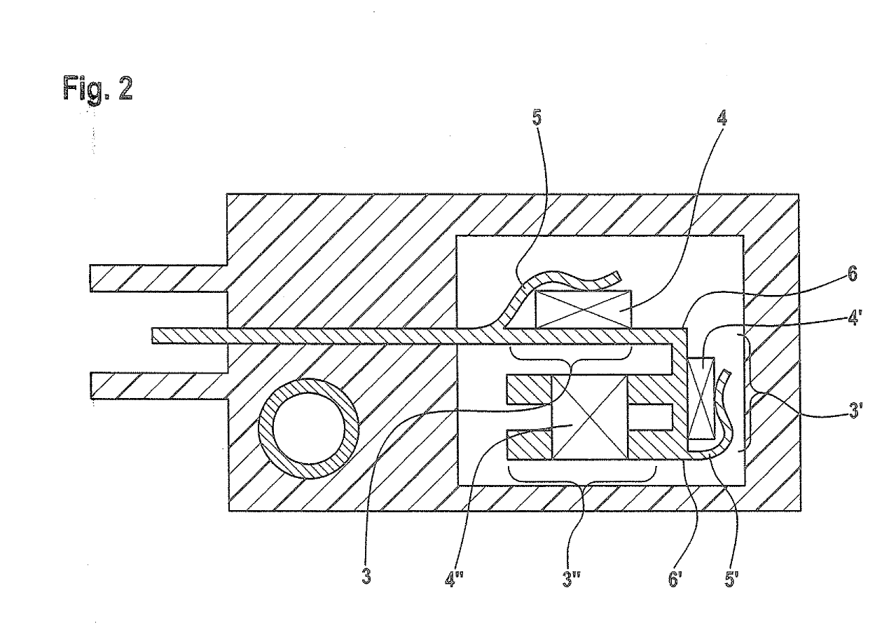

FIG. 2 shows a schematic sectional view of a sensor module 1 according to a second specific embodiment of the present invention. The second specific embodiment is essentially identical to the first specific embodiment illustrated in FIG. 1, conductive part 2 having a third accommodating area 3″, in which, similarly to first and second sensor elements 4, 4′, a third sensor element 4″ is fastened with the aid of a third fastening clamp 5″ (not illustrated for the sake of clarity). Third sensor element 4″ is soldered to conductive part 2, or glued with the aid of a conductive adhesive, or clamped in third accommodating area 3″. Between second accommodating area 3′ and third accommodating area 3″, conductive part 2 has another bent area 6′, in which conductive part 2 is bent or kinked by an angle 7′ in such a way that third accommodating area 3″ is angled with respect to second accommodating area 3′.

In the present exemplary embodiment third accommodating area 3″ is angled by an angle 7′ of approximately 90° with respect to second accommodating area 3′. The sensing axes or sensing planes of first, second, and third sensor elements 4, 4′, 4″ are therefore at a right angle to each other. However, implementing any other angle 7′ between 0° and 180° would also be conceivable here. First, second, and third sensor elements 4, 4′, 4″ are in turn integrated with a portion of conductive part 2 into housing 8, which, together with plug area 7, is enclosed by an external housing 8′.

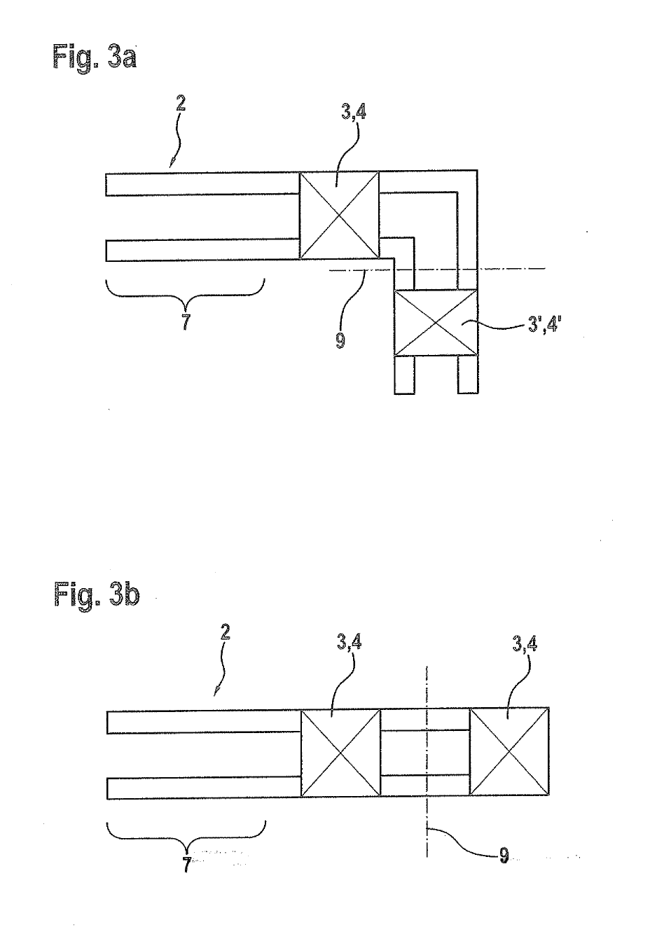

FIGS. 3a and 3b show schematic top views of a conductive part 2 of a sensor module 1 in the initial state according to a third and a fourth specific embodiment of the present invention. FIG. 3a shows the initial shape of a conductive part 2, from which a conductive part 2 of a sensor module 1 according to the present invention is produced by kinking the initial shape about a bending axis 9 by an angle 7. First accommodating area 3 for accommodating first sensor element 4 and second accommodating area 3′ for accommodating second sensor element 4′ are situated at an angle to each other after the kinking process. The initial shape of conductive part 2 has an L shape.

FIG. 3b shows the initial shape of conductive part 2 for sensor module 1 illustrated in FIG. 1, according to the first specific embodiment. To implement sensor module 1 according to the first specific embodiment, conductive part 2 is bent 90° according to bending axis 9. First and second sensor elements 4, 4′ are then oriented at a right angle to each other. The initial shape of this conductive part 2 has an I shape. According to the desired relative placing of first and second sensor elements 4, 4′ an initial shape of conductive part 2, configured as an L or an I shape, is thus selected. The fastening clamps are not illustrated here for the sake of clarity.

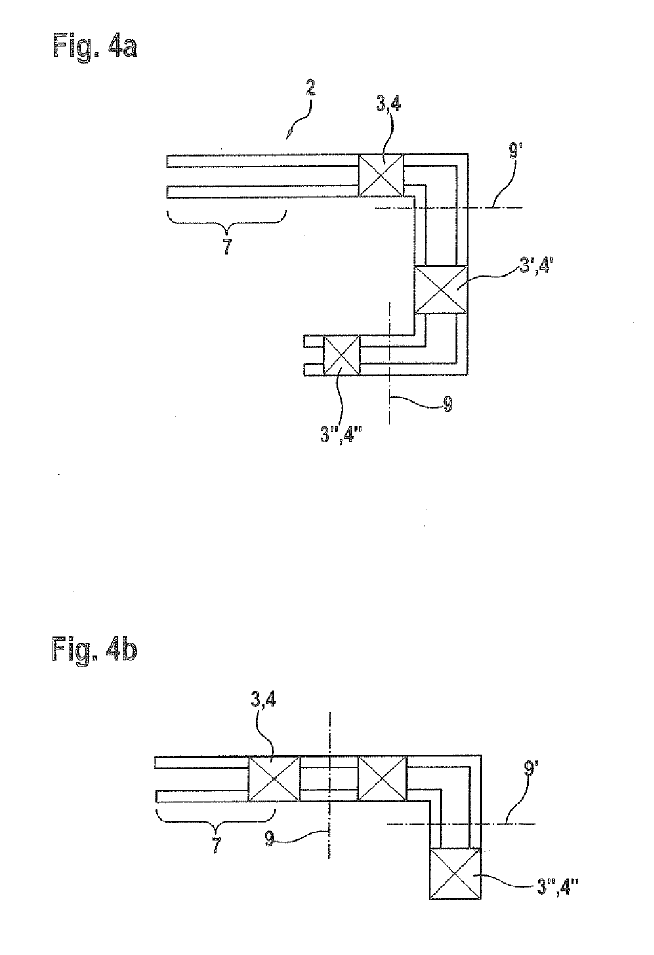

FIGS. 4a and 4b show schematic top views of a conductive part 2 of a sensor module 1 in the initial state according to a fifth and a sixth specific embodiment of the present invention. The initial shapes are essentially similar to the initial shapes illustrated in FIGS. 3a and 3b, another bending axis 9′ between second accommodating area 3′ and third accommodating area 3″ being implemented to place three separate sensor elements, first, second, and third sensor elements 4, 4′, 4″ at an angle to each other. The initial shape is bent initially about bending axis 9 and then about additional bending axis 9′, each time by a desired angle 7, to produce sensor element 1. The initial shape of conductive part 2 has a U shape.

FIG. 4b shows the initial shape of conductive part 2 for sensor module 1 illustrated in FIG. 2, according to the second specific embodiment. To implement sensor module 1 according to the second specific embodiment, conductive part 2 is bent 90° about bending axis 9 and additional bending axis 9′, in each case. First, second, and third sensor elements 4, 4′, 4″ are then oriented at a right angle to each other. The initial shape of this conductive part 2 has an L shape. Depending on the desired relative placing of first, second, and third sensor elements 4, 4′, 4″, an initial shape of conductive part 2, configured as a U- or an L-shape, is thus selected. The fastening clamps are not illustrated here for the sake of clarity.

What is claimed is:

1. A sensor module, comprising:
an electrically conductive part;
a first sensor element being situated in a first accommodating area of the conductive part; and
a second sensor element being situated in a second accommodating area of the conductive part;
wherein the conductive part includes a bent area situated between the first and the second accommodating areas so that the second accommodating area is oriented at an angle with respect to the first accommodating area.

2. The sensor module of claim 1, wherein the first accommodating area is angled essentially at 90° with respect to the second accommodating area.

3. The sensor module of claim 1, wherein the sensor module has a third sensor element, which is situated in a third accommodating area of the conductive part, the conductive part having another bent area situated between the second and the third accommodating areas, so that the third accommodating area is angled with respect to the second accommodating area.

4. The sensor module of claim 1, wherein the third accommodating area is oriented essentially perpendicularly both to the first accommodating area and to the second accommodating area.

5. The sensor module of claim 1, wherein the conductive part is at least partially enclosed by a housing, which includes an injection-molded plastic material.

6. The sensor module of claim 1, wherein the conductive part has at least one of a first fastening clamp for fastening the first sensor element in the first accommodating area, a second fastening clamp for fastening the second sensor element in the second accommodating area, and a third fastening clamp for fastening the third sensor element in the third accommodating area.

7. A method for manufacturing a sensor module, as recited in one of the preceding claims, the method comprising:
(a) providing a conductive part, which has a first accommodating area for accommodating a first sensor element and a second accommodating area for accommodating a second sensor element; and
(b) bending the conductive part in an area situated between the first accommodating area and the second accommodating area so that the second accommodating area is oriented at an angle with respect to the first accommodating area;
wherein the sensor module, includes:
an electrically conductive part;
the first sensor element being situated in the first accommodating area of the conductive part; and
the second sensor element being situated in the second accommodating area of the conductive part.
wherein the conductive part includes a bent area situated between the first and the second accommodating areas so that the second accommodating area is oriented at an angle with respect to the first accommodating area.

8. The method of claim 7, wherein in (a), the conductive part has a third accommodating area for accommodating a third sensor element, further comprising:
(c) bending the conductive part in an additional area situated between the second accommodating area and the third accommodating area so that the third accommodating area is oriented at an angle with respect to the second accommodating area.

9. The method of claim 8, further comprising:
placing at least one of the first sensor element in the first accommodating area, the second sensor element in the second accommodating area, and the third sensor element in the third accommodating area with the aid of at least one of a soldering procedure, a gluing procedure, a clamping procedure, and an insertion procedure.

10. The method of claim 9, further comprising:
extrusion coated using a plastic, for manufacturing a housing, the conductive part, together with at least one of the first sensor element, the second sensor element, and the third sensor element.

11. The method of claim 7, further comprising:
placing at least one of the first sensor element in the first accommodating area, the second sensor element in the second accommodating area, and the third sensor element in the third accommodating area with the aid of at least one of a soldering procedure, a gluing procedure, a clamping procedure, and an insertion procedure.

12. The method of claim 7, further comprising:
extrusion coated using a plastic, for manufacturing a housing, the conductive part, together with at least one of the first sensor element, the second sensor element, and the third sensor element.
